(19) United States
(12) Patent Application Publication
(10) Pub. No.: US 2017/0205986 A1
(43) Pub. Date: Jul. 20, 2017

(54) ELECTRONIC DEVICE AND REMOTE CONTROL METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventor: LEI SUN, Shenzhen (CN)

(21) Appl. No.: 15/353,705

(22) Filed: Nov. 16, 2016

(30) Foreign Application Priority Data
Jan. 14, 2016 (CN) 201610022227.5

(51) Int. Cl. G06F 3/0481; G06F 3/0488; G06F 3/0482; G06F 3/0484; G06F 3/041; G06F 3/14

(52) U.S. Cl. CPC G06F 3/04817; G06F 3/0414; G06F 3/14; G06F 3/0482; G06F 3/0484; G06F 3/04883; G09G 2370/06; G09G 5/12

(57) ABSTRACT

An electronic device with a processing device and a storage device for controlling the operations of several appliances also has a pressure sensing device and a communication device. The processing device receives a press signal of a press detected by the pressure sensing device, and determines a specific command for a selected appliance based on the press signal. The specific command is transmitted to the appliance via the communication device for controlling the appliance to execute the specific command.

### CROSS-REFERENCE TO RELATED APPLICATIONS

This application claims priority to Chinese Patent Application No. 201610022227.5 filed on Jan. 14, 2016, the contents of which are incorporated by reference herein.

### FIELD

The subject matter herein generally relates to remote control of an appliance.

### BACKGROUND

Most home appliances are not equipped with a remote control, so users should press a button on the home appliances for control. Thus, it is not convenient for the users who need or prefer to control the home appliances remotely.

### BRIEF DESCRIPTION OF THE DRAWINGS

Implementations of the present technology will now be described, by way of example only, with reference to the attached figures.

FIG. 1 is a block diagram of one embodiment of an electronic device coupled to an appliance.

FIG. 2 is a block diagram of one embodiment of an operating interface shown on the display device of the electronic device.

FIG. 3 is a block diagram of one embodiment of a control interface shown on the display device of the electronic device.

FIG. 4 illustrates a flowchart of one embodiment of a remote control method for the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts can be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

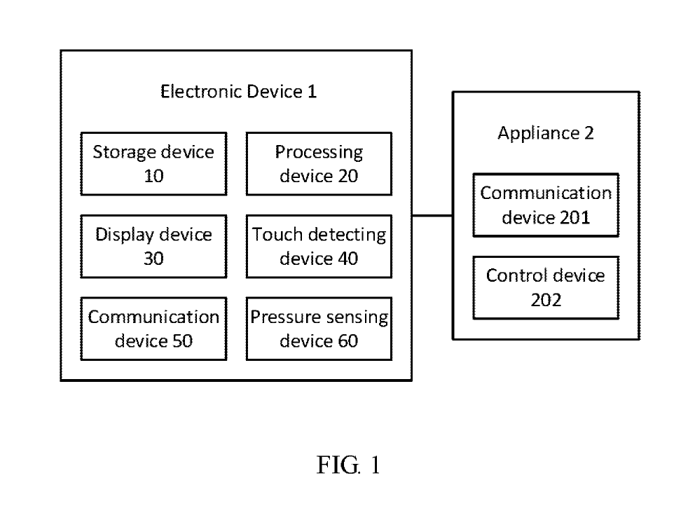

FIG. 1 illustrates an embodiment of an electronic device 1 coupled to an appliance 2. In the embodiment, the electronic device 1 can include a storage device 10, a processing device 20, a display device 30, a touch detecting device 40, a communication device 50, and a pressure sensing device 60. The storage device 10, the display device 30, the touch detecting device 40, the communication device 50, and the pressure sensing device 60 are coupled to the processing device 20 via a system bus.

In at least one embodiment, the electronic device 1 can be a mobile phone, a tablet, a desktop, a notebook, or other electronic device. FIG. 1 illustrates only one example of an electronic device 1, the electronic device 1 in other embodiments can include more or fewer components than as illustrated, or have a different configuration of the various components.

In at least one embodiment, the storage device 10 can be a non-volatile computer readable storage medium that can be electrically erased and reprogrammed, such as read-only memory (ROM), random-access memory (RAM), erasable programmable ROM (EPROM), electrically EPROM (EEPROM), hard disk, solid state drive, or other forms of electronic, electromagnetic, or optical recording medium. In at least one embodiment, the storage device 10 can include interfaces that can enable access to the aforementioned computer readable storage medium, to enable the electronic device 1 to connect to and access such computer readable storage medium. In another embodiment, the storage device 10 can include network accessing device to enable the electronic device 1 to connect and access data stored in a remote server or a network-attached storage.

In at least one embodiment, the processing device 20 can be a processor, a central processing unit (CPU), a graphic processing unit (GPU), a system on chip (SoC), a field-programmable gate array (FPGA), or a controller for executing the program instruction in the storage device 10. The processing device 20 can further include an embedded system or an application specific integrated circuit (ASIC) having embedded program instructions.

In at least one embodiment, the display device 30 can show an operating interface 300. Thus, the display device 30 can include a display using liquid crystal display (LCD) technology, an organic light emitting diode (OLED) display technology, or light emitting polymer display (LPD) technology, although other display technologies can be used in other embodiments.

In at least one embodiment, the touch detecting device 40 can be integrated with the display device 30 to form a touch screen, such as an LCD touch screen or an OLED touch screen, for detecting at least one touch on the display device 30. The touch detecting device 40 can be a resistive touch sensor, a capacitive touch sensor, or other forms of electronic or optical sensor to determine coordinates of the touch. In at least one embodiment, the touch detecting device 40 can be a touch pad separated from the display device 30 and controlling a cursor shown in the display device 30.

In at least one embodiment, the communication device 50 can adopt customizable protocols or follow existing standards or de facto standards such as BLUETOOTH, ETHERNET, IEEE 802.11 and IEEE 802.15 series, Wireless USB, infrared communication or telecommunication standards such as GSM, CDMA2000, TD-SCDMA, WiMAX, 3GPP-LTE, and TD-LTE.

In at least one embodiment, the pressure sensing device 60 can be a pressure sensor. The pressure sensor can be installed under the touch screen having the display device 30 and the touch detecting device 40 so rendering a pressure sensing area of the pressure sensing device 60 the same as a touch detecting area of the touch detecting device 40. In at least one embodiment, the pressure sensing device 60 can be integrated with the touch pad to sense pressure signal.

In the embodiment, the appliance 2 can include a communication device 201 and a control device 202 coupled to the communication device 201. In at least one embodiment, the appliance 2 can be an electric light, a fan, an air conditioner, a television, or other device. FIG. 1 illustrates only one example of an appliance 2, the appliance 2 in other embodiments can include more or fewer components than as illustrated, or have a different configuration of the various components.

In at least one embodiment, the communication device 201 can adopt customizable protocols or follow existing standards or de facto standards such as BLUETOOTH, ETHERNET, IEEE 802.11 and IEEE 802.15 series, Wireless USB, infrared communication or telecommunication standards such as GSM, CDMA2000, TD-SCDMA, WiMAX, 3GPP-LTE, and TD-LTE to communicate with the communication device 50 of the electronic device 1. In at least one embodiment, the control device 202 can be a control chip or a board including a control circuit to control the operation of the appliance 2.

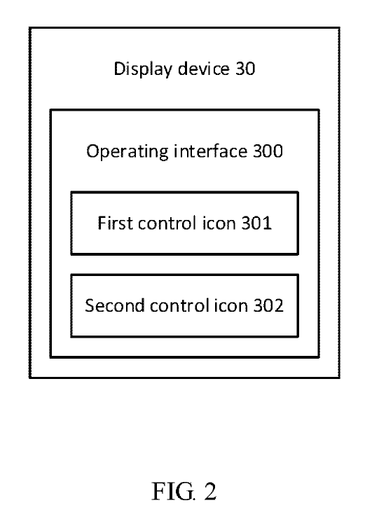

FIG. 2 illustrates an embodiment of an operating interface 300 shown in the display device 30. In the embodiment, the processing device 20 controls the display device 30 to show the operating interface 300 when the touch detecting device 40 detects a first touch, such as a touch for selecting an operating icon.

In at least one embodiment, the electronic device 1 can communicate with a plurality of appliances 2. The operating interface 300 can include a plurality of control icons 301 and 302, each of the control icons can correspond to one of a plurality of appliances 2. Thus, each of the control icons shown in the operating interface 300 represents one of the appliances controlled by the electronic device 1. In the embodiment, the operating interface 300 can include a first control icon 301 and a second icon 302.

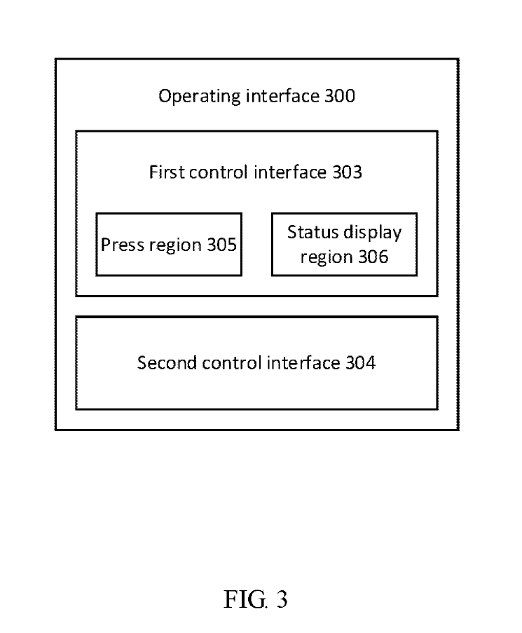

FIG. 3 illustrates an embodiment of a control interface of the operating interface 300 shown in the display device 30. In the embodiment, the processing device 20 can control the display device 30 to show a first control interface 303, corresponding to a specific appliance 2, in the operating interface 300 when the first control icon 301 is selected. In at least one embodiment, the first control interface 303 can include a press region 305 and a status display region 306. When the electronic device 1 communicates with the specific appliance 2, the touch detecting device 40 can detect whether the user touches the press region 305 in the first control interface 303. The status display region 306 can show an operating status of the specific appliance 2, such as ON/OFF status and other performance factors.

In at least one embodiment, the operating interface 300 can show the first control interface 303 corresponding to the first control icon 301 and a first appliance, and a second control interface 304 corresponding to the second control icon 302 and a second appliance. For example, the first control interface 303 can be a control interface of a fan when that is the first appliance corresponding to the first control icon 301. The second control interface 304 can be a control interface of an electric heater when that is the second appliance corresponding to the second control icon 302.

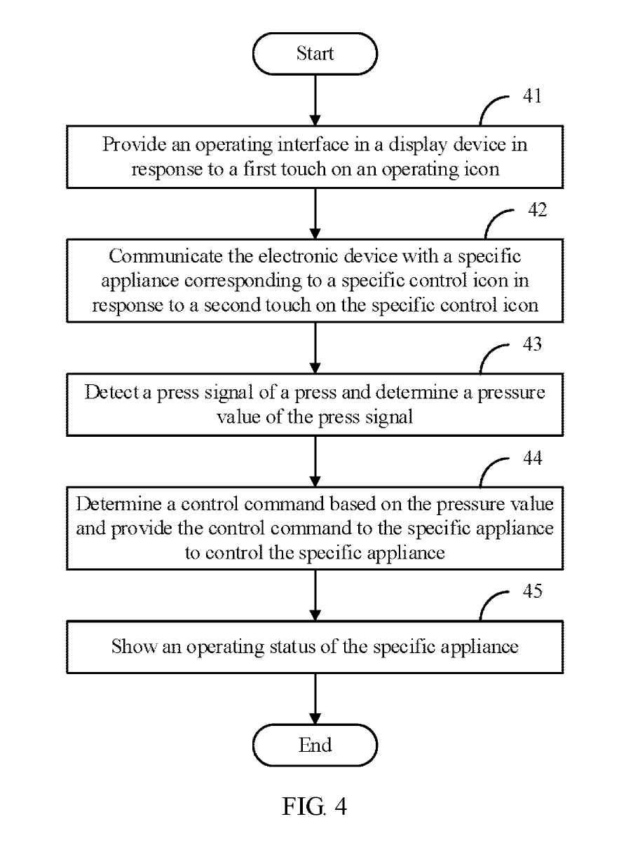

FIG. 4 illustrates a flowchart in accordance with an example embodiment. The example method is provided by way of example, as there are a variety of ways to carry out the method. The method described below can be carried out using the configuration illustrated in FIG. 1, for example, and various elements of these figures are referenced in explaining example method. Each block shown in FIG. 4 represents one or more processes, methods, or subroutines, carried out in the example method. Furthermore, the order of blocks is illustrative only and can change. Additional blocks can be added or fewer blocks can be utilized without departing from this disclosure. The example method can begin at block 41.

At block 41, the processing device 20 provides an operating interface 300 in the display device 30 in response to a first touch selecting an operating icon. In the embodiment, the operating interface 300 can include a plurality of control icons, each of the control icons corresponds to one of a plurality of appliances 2.

In at least one embodiment, the storage device 10 stores the remote control system. The display device 30 shows an operating icon corresponding to the remote control system. In at least one embodiment, the touch detecting device 40 can detect the operating icon being selected by the first touch from a user. When the user needs to control an appliance, the user can select the operating icon by the first touch to execute the remote control system. When the touch detecting device 40 detects the first touch selecting the operating icon, the processing device 20 can determine that the remote control system should be executed to control an appliance.

In at least one embodiment, the remote control system can include one or more modules. “Module,” as used herein, refers to logic embodied in hardware or firmware, or to a collection of software instructions, written in a programming language, such as, JAVA, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable medium include CDs, DVDs, BLU-RAY, flash memory, and hard disk drives.

In at least one embodiment, the electronic device 1 can communicate with a plurality of appliances 2. The processing device 20 controls the display device 30 to show a plurality of control icons in the operating interface 300 when the touch detecting device 40 detects the first touch selecting the operating icon. Each of the control icons corresponds to one of a plurality of appliances 2. Thus, each of the appliances 2 controlled by the electronic device 1 can be represented by one of the control icons shown in the operating interface 300. In the embodiment, the operating interface 300 can include a first control icon 301 and a second control icon 302.

At block 42, the processing device 20 controls the communication device 50 to establish a communication with a specific appliance 2 in response to a second touch which selects a specific control icon corresponding to the specific appliance 2.

In at least one embodiment, the touch detecting device 40 can detect one of the control icons being selected by the second touch from the user. When the touch detecting device 40 detects the second touch selecting the specific control icon, the communication device 50 can establish the communication between the electronic device 1 and the specific appliance 2 corresponding to the specific control icon.

In the embodiment, the processing device 20 can control the display device 30 to show, in the operating interface 300, a first control interface 303 corresponding to a first appliance 2, when the first control icon 301 is selected. In at least one embodiment, the first control interface 303 can include a press region 305. When the electronic device 1 communicates with the first appliance 2 corresponding to the first control icon 301, the touch detecting device 40 can detect whether the user touches the press region 305 in the first control interface 303.

At block 43, the processing device 20 controls the pressure sensing device 60 to detect a press signal of a press and determines a pressure value of the press signal.

In at least one embodiment, the touch detecting device 40 can detect a press region 305 being pressed by a third touch from a user. When the touch detecting device 40 detects the third touch on the press region 305, the pressure sensing device 60 can regard the third touch as the press and detect the press signal of the third touch.

In at least one embodiment, the processing device 20 can control the pressure sensing device 60 to detect the press within the press region 305, and determine the pressure value of the press in response the detection of the press.

At block 44, the processing device 20 receives the press signal, determines a specific command based on the pressure value of the press signal, and transmits the specific command to control the specific appliance 2. In the embodiment, the specific appliance 2 receives the specific command via the communication device 201 and executes the specific command through the control device 202.

In at least one embodiment, the processing device 20 can generate a plurality of control commands, and select the specific command based on the pressure value from the plurality of control commands. In at least one embodiment, each control command received by the specific appliance 2 causes the specific appliance 2 to perform a specific function.

In at least one embodiment, the processing device 20 can set a plurality of pressure levels, each pressure level corresponds to one of the control commands. Thus, the processing device 20 can compare the pressure value with the plurality of pressure levels to determine which one of the pressure levels the pressure value belongs to, and determine the specific command from the control commands based on the determined pressure level. For example, when the specific appliance 2 controlled by the electronic device 1 is a fan, the plurality of pressure levels for the fan may be predefined as a first pressure level 0-1N, a second pressure level 1-3N, and a third pressure level 3-5N.

When the sensed pressure value belongs to the first pressure level, the processing device 20 can generate a first specific command for turning on the fan. When the sensed pressure value belongs to the second pressure level, the processing device can generate a second specific command for changing a rotation speed of blades in the fan. When the sensed pressure value belongs to the third pressure level, the processing device can generate a third specific command for changing a wind direction of the fan.

In at least one embodiment, the plurality of pressure levels can further include a fourth pressure level 1-2N, a fifth pressure level 2-3N, a sixth pressure level 3-4N, and a seventh pressure level 4-5N. When the sensed pressure value belongs to the fourth pressure level, the processing device can generate a fourth specific command for setting the fan to rotate at a first rotation speed. When the sensed pressure value belongs to the fifth pressure level, the processing device can generate a fifth specific command for setting the fan to rotate at a second rotation speed. When the sensed pressure value belongs to the sixth pressure level, the processing device can generate a sixth specific command for controlling the fan to swing right and left. When the sensed pressure value belongs to the seventh pressure level, the processing device can generate a seventh specific command for controlling the fan to swing vertically instead of laterally.

In at least one embodiment, the communication device 201 of the specific appliance 2 receives the specific command from the processing device 20. The control device 202 controls the specific appliance 2 based on the specific command received by the communication device 201. For example, if the specific appliance 2 is a fan, the control device 202 can control the fan to be turned on, to increase the rotation speed of the blades in the fan, or to change the wind direction of the fan based on the specific command received by the communication device 201.

At block 45, the processing device 20 controls the display device 30 to show an operating status of the specific appliance 2.

In at least one embodiment, the operating interface 300 can show a control interface of the specific appliance 2 corresponding to the specific control icon when the user selects the specific control icon on the operating interface 300. In the embodiment, the first control icon can correspond to the first control interface 303 and the second control icon can correspond to the second control interface 304. Thus, the operating interface 300 can show the first control interface 303 of the first appliance 2 corresponding to the first control icon 301 when the user selects the first control icon 301 on the operating interface 300. For example, the first control interface 303 can be a control interface of a fan when that is the first appliance 2 corresponding to the first control icon 301. The second control interface 304 can be a control interface of an electric heater when that is the second appliance 2 corresponding to the second control icon 302.

In at least one embodiment, the first control interface 303 can include a press region 305 and a status display region 306. The press region 305 can be a region for the user to press. The status display region 306 can show an operating status of the first appliance 2, such as current wind speed or current wind direction of the fan.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims.

1. An electronic device, comprising:
a processing device;
a pressure sensing device coupled to the processing device and detecting a press to generate a press signal;
a communication device coupled to the processing device and communicating with an appliance; and
a storage device coupled to the processing device and storing a plurality of instructions which, when executed by the processing device, cause the processing device to:
receive the press signal from the pressure sensing device;
determine a specific command based on the press signal; and
provide the specific command to the appliance via the communication device to control the appliance to execute the specific command;
wherein the processing device determines a pressure value of the press signal, compares the pressure value with a plurality of pressure levels to determine which one of the pressure levels the pressure value belongs to, and determines the specific command based on the determined pressure level.

2. The electronic device according to claim 1, further comprising:
a display device coupled to the processing device; and
a touch detecting device coupled to the processing device and detecting a touch on the display device.

3. The electronic device according to claim 2, wherein the processing device controls the display device to show a plurality of control icons in an operating interface when the touch detecting device detects the touch on an operating icon shown in the display device.

4. The electronic device according to claim 3, wherein the processing device controls the communication device to communicate with the appliance when a specific one of the control icons corresponding to the appliance is touched.

5. The electronic device according to claim 3, wherein the processing device controls the display device to show a control interface when a specific one of the control icons corresponding to the appliance is touched.

6. The electronic device according to claim 5, wherein the control interface comprises a press region for the pressure sensing device to detect the press signal of the press and a status display region showing an operating status of the appliance.

7. (canceled)

8. A remote control method for an electronic device to control one of a plurality of appliances, the method comprising:
communicating, via a communication device of the electronic device, with a specific one of the appliances;
detecting, by a pressure sensing device of the electronic device, a press to generate a press signal;
determining a pressure value of the press signal;
comparing the pressure value with a plurality of pressure levels to determine which one of the pressure levels the pressure value belongs to;
determining a specific command based on the determined pressure level; and
providing the specific command to the specific appliance via the communication device to control the specific appliance to execute the specific command.

9. The method according to claim 8, comprising:
showing, by a display device of the electronic device, a plurality of control icons in an operating interface, wherein each of the control icons is corresponding to one of the plurality of appliances; and
determining the specific appliance when a specific one of the control icons corresponding to the specific appliance is touched.

10. The method according to claim 9, comprising:
showing a control interface corresponding to the specific appliance in the display device for controlling the specific appliance.

11. The method according to claim 10, wherein the control interface comprises a press region for the pressure sensing device to detect the press signal of the press and a status display region showing an operating status of the specific appliance.

12. (canceled)
